(19) United States
(12) Patent Application Publication
(10) Pub. No.: US 2007/0227108 A1
(43) Pub. Date: Oct. 4, 2007

(54) HYDROCARBON FILTER, FRAME FOR FIXING HYDROCARBON FILTER, AND AIR CLEANER

(75) Inventor: Kosaku Ishida, Yokohama-shi (JP)

Correspondence Address: HARNESS, DICKEY & PIERCE, P.L.C., P.O. BOX 828, BLOOMFIELD HILLS, MI, 48303, US

(73) Assignee: Tokyo Roki Co., Ltd., Kanagawa (JP)

(21) Appl. No.: 11/691,651

(22) Filed: Mar. 27, 2007

(30) Foreign Application Priority Data
Mar. 29, 2006 (JP) 2006-90734

(51) Int. Cl. B01D 39/00

(52) U.S. Cl. 55/521

(57) ABSTRACT

An HC filter (10) for use in an air cleaner (200) comprises an absorbent that absorbs hydrocarbon (HC) contained in vaporized fuel and a support that supports the absorbent. The support is of a paper honeycomb structure and has a surface thereof coated. An HC filter fixing frame (20) for attaching the HC filter in the housing of the air cleaner comprises a frame-like body (21) and a lattice (22). The lattice (22) is placed so as not to contact the HC filter (10), and bosses (30) are provided on the side of the lattice facing the HC filter, which contact and hold the HC filter at a side thereof. In the air cleaner (200), an HC filter unit (100) consisting of the HC filter (10) and the HC filter fixing frame (20) can be situated over the entire cross-section of the passage at a position adjacent to sealing faces.

### BACKGROUND ART

1. Technical Field

The present invention relates to an HC filter for absorbing hydrocarbon contained in vaporized fuel leaked out of an air intake system of an internal combustion engine, an HC filter fixing frame for fixing the HC filter to a secondary case, and an air cleaner provided with an HC filter unit.

2. Related Art

The air intake system of the engine of a vehicle or the like is connected to an air cleaner and air taken in from the outside atmosphere is filtered by the air cleaner and supplied to the engine.

The air cleaner has a primary case having an inlet in communication with the outside atmosphere and a secondary case having an outlet in communication with the engine, the primary case being provided with an air element for filtering the outside air.

Where an air cleaner is provided in the air intake system of an engine, for example, while the engine is at rest, vaporized fuel may leak out of the engine and flow out through the air cleaner to the outside atmosphere. Since the vaporized fuel contains hydrocarbon (HC) that is one of pollution causes, the vaporized fuel, as it is, flowing out to the outside atmosphere causes air pollution.

Accordingly, air cleaners having an HC filter unit provided in its secondary case have been developed. The HC filter unit has an HC filter for absorbing hydrocarbon contained in vaporized fuel and an HC filter fixing frame for fixing the HC filter to the secondary case.

Conventionally, as such an HC filter, various types of products have been developed. There are HC filters having a ceramic-made honeycomb structure (hereinafter also called a “ceramic honeycomb”), which is particularly superior in air flow characteristics (refer to, for example, U.S. Pat. No. 6,835,237 and Japanese Patent Application Laid-Open Publication Nos. 2002-276486 and 2006-2730). As to the HC filter fixing frame, there are ones that use a lattice-like holding frame (refer to, for example, U.S. Pat. No. 6,835,237 and Japanese Patent Application Laid-Open Publication Nos. 2002-276486 and 2006-2730).

In order to maximize the absorbing capability thereof, an HC filter is preferably situated over the entire cross-section of the passage at a position adjacent to sealing faces of the air cleaner, that is, the entire cross-section of the passage for vaporized fuel at a position adjacent to the joint of the primary case and the secondary case. However, in order to situate a ceramic-made HC filter over the entire cross-section of the passage at a position adjacent to the sealing faces at which air-flow resistance is high, the ceramic honeycomb structure thereof needs to be scaled up And the wall thickness of the honeycomb needs to be made thicker to ensure filter strength, which cause an increase in cost since ceramic is usually expensive. Furthermore, because conventional HC filter fixing frames arc placed such that the lattice portion of their holding frame contacts an HC filter to brace the HC filter, the HC filter fixing frame hurts the absorbing capability of the HC filter and increases the air-flow resistance thereof. Moreover, conventional air cleaners, which are provided with an HC filter unit having a ceramic honeycomb and an HC filter fixing frame, have similar problems in cost and capability.

### SUMMARY OF THE INVENTION

The present invention was made in view of the above problems of the prior art, and an object thereof is to provide an HC filter of low cost that. can be situated over the entire cross-section of the passage at a position adjacent to the sealing faces of an air cleaner.

Another object of the present invention is to provide an HC filter fixing frame that can reduce air-flow resistance without hurting the absorbing capability of the HC filter.

Yet another object of the present invention is to provide an air cleaner of low cost and nigh performance.

To solve the above problems, according to the present invention, there is provided an HC filter for use in an air cleaner that comprises a housing having an inlet through which air is taken in from an outside atmosphere and an outlet through which the air taken in through the inlet is supplied to an engine; and an air element housed in the housing, which filters the air taken in through the inlet. The HC filter comprises an absorbent that absorbs hydrocarbon (HC) contained in vaporized fuel introduced through the outlet; and a support that supports the absorbent. The HC filter defines an inside of the housing and is placed on the engine side of the air element, and the support is of a paper honeycomb structure and has a surface thereof coated.

According to another aspect of the present invention. there is provided an HC filter fixing frame for attaching an HC filter in a housing of an air cleaner. The HC filter fixing frame comprises a frame like body having an opening formed therein that is open at both sides and having formed thereon opening side walls and an attaching portion at which the frame-like body is attachable to the housing, the opening side walls holding the HC filter at its outer edges, which filter is stored into the opening from one side of the frame-like body; and a lattice provided on the other side of the frame-like body that divides the opening into a plurality of sub-openings. The lattice is placed so as not to contact the stored HC filter, and bosses are provided on the side of the lattice facing the HC filter, which contact and hold the HC filter at a side thereof.

In the HC filter fixing frame, the bosses may be provided at intersections of the lattice.

According to yet another aspect of the present invention, there is provided an air cleaner that comprises a housing having an inlet through which air is taken in from an outside atmosphere and an outlet through which the air taken in through the inlet is supplied to an engine; an air element housed in the housing, which filters the air taken in through the inlet; an HC filter that defines an inside of the housing and is placed on the engine side of the air element and that comprises an absorbent that absorbs hydrocarbon (HC) contained in vaporized fuel introduced through the outlet, and a support that supports the absorbent; and an SC filter fixing frame for attaching the HC filter in the housing of the air cleaner. The support of the HC filter is of a paper honeycomb structure and has a surface thereof coated.

In the air cleaner, the HC filter fixing frame may comprise a frame-like body having an opening formed therein that is open at both sides and having formed thereon opening side walls and an attaching portion at which the frame-like body is attachable to the housing, the opening side wall holding the HC filter at its outer edges, which filter is stored into the opening form one side of the frame-like body; and a lattice provided on the other side of the frame-like body that divides the opening into a plurality of sub-openings. The lattice may be placed so as not to contact the stored HC filter, and bosses may be provided on the side of the lattice facing the HC filter, which contact and hold the HC filter at a side thereof.

### BRIEF DESCRIPTION OF THEFT DRAWINGS

For a more complete understanding of the present invention and the advantages thereof, reference is now made to the following description taken in conjunction with the accompanying drawings wherein:

FIG. 1 is an exploded perspective view of an HC filter unit according to one embodiment of the present invention,

FIG. 2A shows a top view of the HC filter unit of FIG. 1 and FIG. 2B shows a sectional view along line A-A of FIG. 1 as viewed in the direction of the arrows;

FIG. 3 is an exploded perspective view of an air cleaner provided with the HC filter unit;

FIG. 4 is a side longitudinal sectional view of the air cleaner of FIG. 3;

FIG. 5 shows a top view of the air cleaner of FIG. 3 and an enlarged sectional view along line B-B of its main part;

FIGS. 6A and 68 show enlarged sectional views of main parts of other embodiments corresponding to that of FIG. 5; and

FIG. 7A shows schematically a test model for verifying the effect of reducing air-flow resistance of the air cleaner and FIG. 7B shows a graph indicating test results obtained with use of the test model of the FIG. 7A.

### DETAILED DESCRIPTION OF THE INVENTION

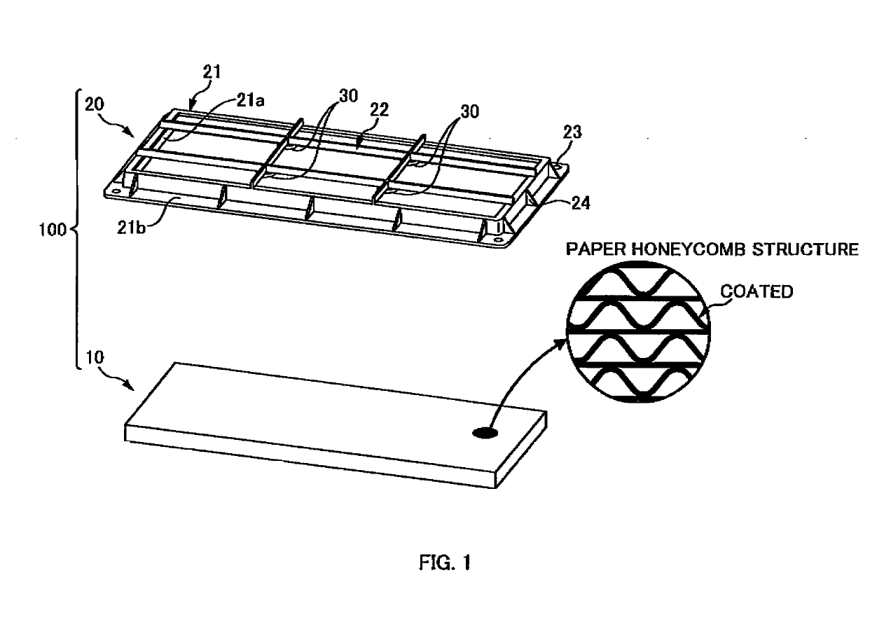

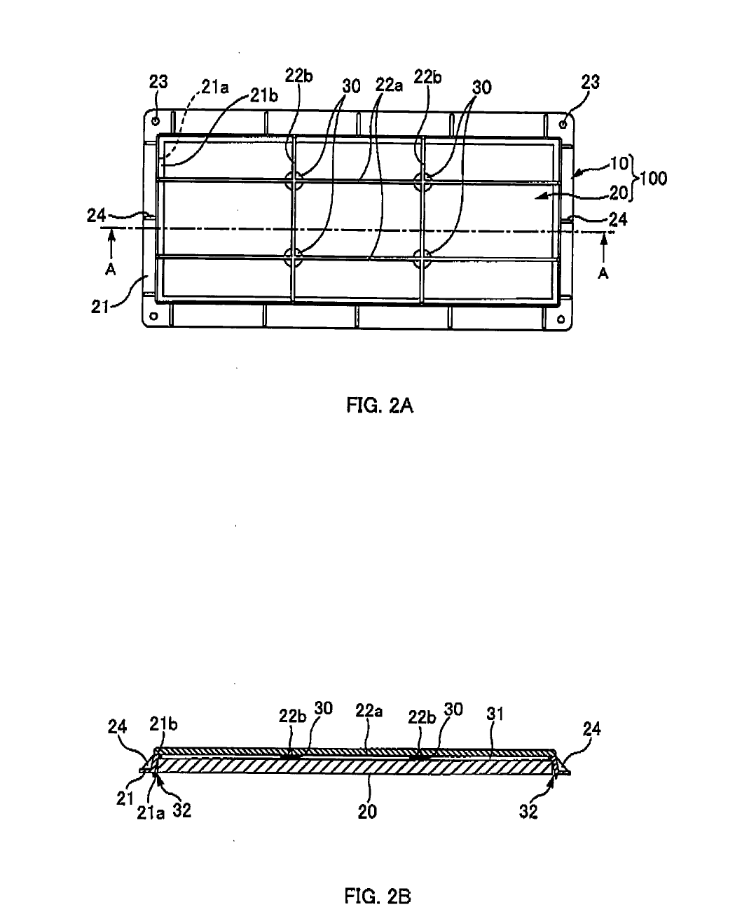

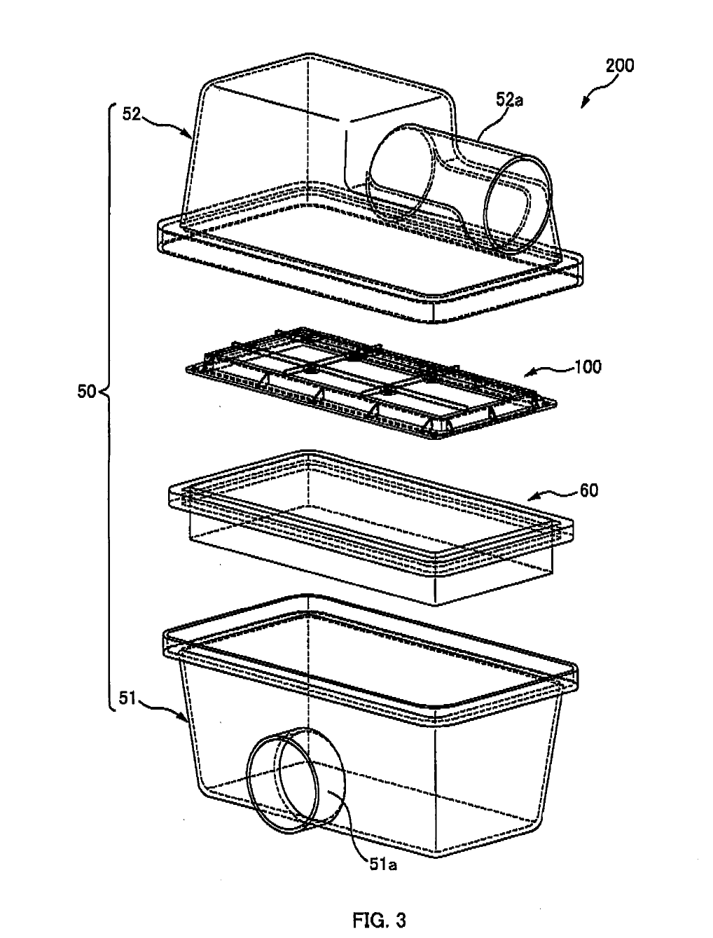

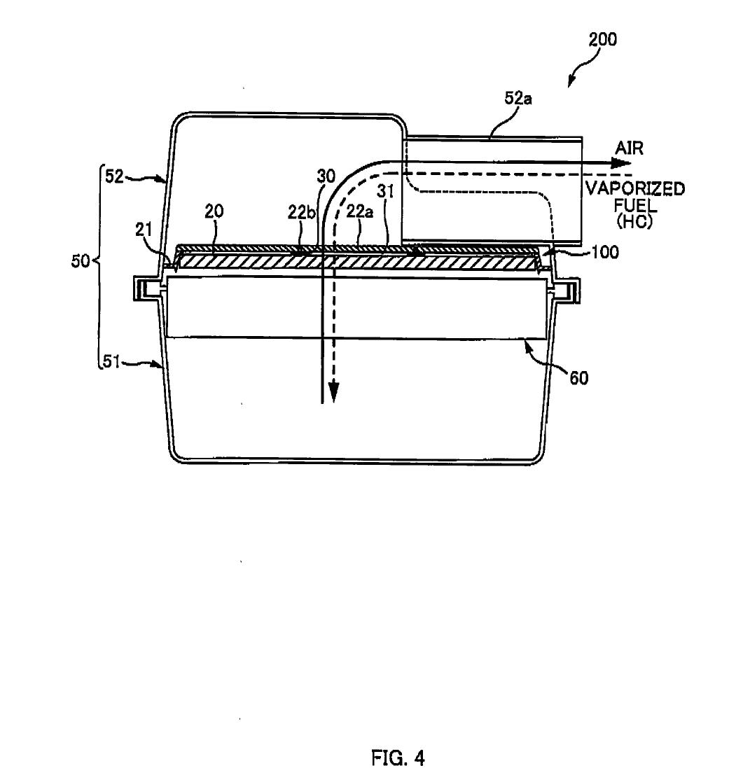

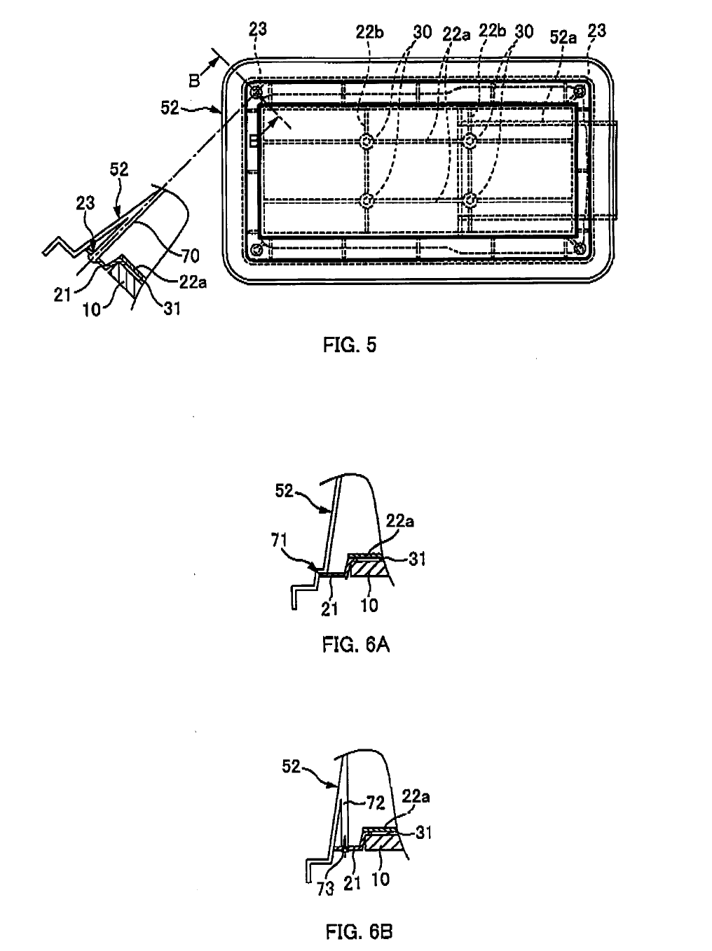

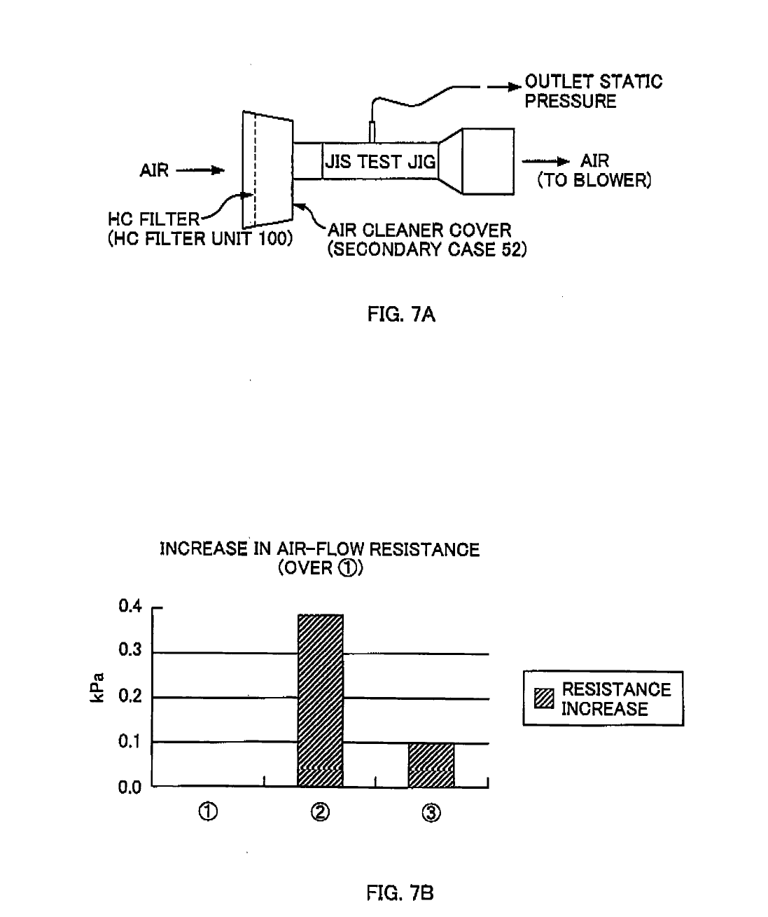

An embodiment of the present invention will be described below with reference to the accompanying drawings. FIG, 1 is an exploded perspective view of an HC filter unit according to one embodiment of the present invention. FIG, 2A is a top view of the HC filter unit of FIG. 1, and FIG. 2B is a sectional view along line A-A of FIG. 1 as viewed in the direction of the arrows. FIG. 3 is an exploded perspective view of an air cleaner provided with the HC filter unit. FIG. 4 is a side longitudinal sectional view of the air cleaner of FIG. 3. FIG. 5 shows a top view of the air cleaner of FIG. 3 and an enlarged sectional view along line B-B of its main part. FIGS. 6A and 6B show enlarged sectional views of main parts of other embodiments corresponding to that of FIG. 5. FIG. 7A shows schematically a test model for verifying the effect of reducing air-flow resistance of the air cleaner of the present invention, and FIG. 7B is a graph showing test results obtained with use of the test model of FIG. 7A.

===HC Filter Units===

As shown in FIGS. 1 and 2, an HC filter unit 100 comprises an HC filter 10 that absorbs hydrocarbon contained in vaporized fuel and an HC filter fixing frame 20 for situating the HC filter 10 over the entire cross-section of the passage at a position adjacent to sealing faces of an air cleaner, both of which are joined together with adhesive.

<HC Filter>

The HC filter 10 has an absorbent (e.g. activated carbon) that absorbs hydrocarbon and a support that supports the absorbent. The support is of a paper honeycomb structure (hereinafter also simply called a “paper honeycomb”) and a surface thereof is coated with a coat.

With this configuration, the support of the HC filter 10 is a paper honeycomb lets expensive than a ceramic honeycomb, thus lowering the cost.

The support of the paper honeycomb structure is weaker in filter strength by its nature than a conventional ceramic honeycomb, and because its end faces are particularly subject to air-flow force, their strength is easily reduced. Thus, where an HC filter of the paper honeycomb type, as it is, is situated over the entire cross-section of the passage at a position adjacent to the sealing faces of the air cleaner, its endurance is reduced, which means not being suitable to be situated in such a position. Further, where the air cleaner is provided in the air intake system of a vehicle or the like, the amount of air passing through the HC filter 10 in very large and the HC filter 10 is in use consecutively. Hence, the HC filter 10 is eroded at the end faces and further on. Thus, pieces of the absorbent supported by the support fly away in a dispersing manner. If the absorbent is activated carbon, pieces of the activated carbon fly away in a remarkable quantity.

Even with the support of the paper honeycomb structure, by coating the surface such as the end faces thereof, filter strength is improved and also the absorbent can be prevented from shedding its pieces to fly away. By this means, the HC filter 10 can be situated over the entire cross-section of the passage at a position adjacent to the sealing faces of the air cleaner. Note that the coating is, for example, to coat the surface of the HC filter 10 with predetermined resin.

Moreover, the paper honeycomb is lighter and more flexible by its nature than a conventional ceramic honeycomb, thus being superior in quake resistance. Hence, even air cleaners to be placed immediately above an engine, which vibrates violently, can use the paper honeycomb as the HC filter,

<HC Filter Fixing Frame>

The HC filter fixing frame 20 comprises a frame-like body 21 having an opening formed therein that is open at both sides and having opening side walls 21a and an attaching portion 21b formed thereon, and a lattice 22 provided on the other side (the upper side in FIG. 1) of the frame-like body 21 that divides the opening into a plurality of sub-openings.

The opening side walls 21a hold the HC filter 10 at its outer edges, which is stored into the opening from one side (the lower side in FIG. 1) of the frame-like body 21, The attaching portion 21b has such a structure that the HC filter can be situated over the entire cross-section of the passage at a position adjacent to sealing faces in a secondary case 52 (see, e.g., FIG. 3). Note that attaching apertures 23 and bracing ribs 24 are provided in and on the attaching portion 21b of FIG. 1.

The lattice 22 comprises longitudinal bars 22a arranged longitudinally of the opening and transverse bars 22b arranged perpendicular to the longitudinal bars 22a.

The HC filter fixing frame 20 has the lattice 22 provided thereon so as not to contact the HC filter 10, Provided on the side of the lattice 22 facing the HC filter 10 is bosses 30 that contact and hold the stored HC filter 10 at its one side. The bosses 30 are preferably provided at intersections of the lattice 22, that is, intersections of the longitudinal bars 22a and the transverse bars 22b (see FIG. 2A). The opening side walls 21a of the frame-like body 21 have a slope formed thereon such that the opening becomes gradually wider from the other side of the frame-like body 21 to the one side (see FIG. 2B).

As such, the HC filter fixing frame 20 has the lattice 22 provided thereon so as not to contact the HC filter 10, and the bosses 30 are provided on the side of the lattice 22 facing the HC filter 10. The bosses 30 are located in a space 31 between the HC filter fixing frame 20 and the HC filter 10, and contact and hold the stored HC filter 10 at its one side to brace the HC filter 10.

With the HC filter fixing frame 20, the lattice 22 does not directly contact the HC filter 10, but point-contacts the HC filter 10 only at the bosses 30 such that the lattice 22 is displaced away from the HC filter 10. Thus, the space 31 is secured between the lattice 22 and the HC filter 10, and air flows through the space 31 into the HC filter 10. By this means, the lattice 22 is inhibited from hurting the absorbing capability of the HC filter 10, and the air-flow resistance of the HC filter 10 is reduced. By securing the space 31, when the number and thickness of the lattice bars are increased or decreased, reduction in the absorbing capability of the HC filter 10 can be suppressed,

Furthermore, since the bosses 30 are provided only at intersections of the lattice 22, reduction in the absorbing capability of the HC filter 10 and increase in the air-flow resistance as well can be suppressed. In the present invention, the shape and locations of the bosses 30 are not limited to those shown in the Figures.

Moreover, the opening side walls 21a of the frame-like body 21 have the slopes formed thereon, and thus a space 32 (of, e.g., about 0.5 mm in width) is formed between the opening side walls 21a and the stored HC filter 10, Hence, when attaching the HC filter 10 to the HC filter fixing frame 20, by causing adhesive to flow into the space 32, the attaching finishes thus improving workability. Note that the adhesive (not shown) need only be applied to the attaching portion 21b and the bosses 30 of the frame-like body 21, which support the HC filter 10. The adhesive is preferably, but not limited to, an adhesive superior in heat resistance, cold resistance, and earthquake resistance. Further, the opening side walls 21a are formed such that the opening becomes narrower at the back in the direction in which to insert the HC filter 10 so as to provide tight attachment. Hence, the opening side walls 21a restrict the position at which the HC filter 10 is attached, thereby preventing the positional deviation of the HC filter 10.

As such, the HC filter 10 is inserted into and fixed to the HC filter fixing frame 20 with adhesive, thereby completing the assembly of the HC filter unit 100. With this HC filter unit 100 having the HC filter 10 of the paper honeycomb structure, the HC filter 10 can be situated over the entire cross-section of the passage at a position adjacent to the sealing faces of the air cleaner.

Incidentally, an Hz filter fixing frame may be designed to be constituted by a pair of the HC filter fixing frames (not shown) that are vertically inverted to each other which can be used to vertically sandwich the HC filter 10, thus making adhesive unnecessary.

===Air Cleaner===

As shown in FIGS. 3 and 4, an air cleaner 200 comprises a housing 50, an air element 60 for filtering outside air taken into the housing 50, and the HC filter unit 100, which removes hydrocarbon contained in vaporized fuel taken into the housing 50.

The housing 50 comprises a primary case 51 having an inlet 51a in communication with the outside atmosphere and the secondary case 52 having an outlet 52a in communication with an engine, and the primary case 51 and the secondary case 52 are joined together tightly.

The air element 60 and the HC filter unit 100 are each situated covering the entire cross-section of the passage for taken-in air and vaporized fuel at a position adjacent to the sealing faces of the air cleaner 200. The air element 60 defines the inside of the primary case 51 and the HC filter unit 100 defines the inside of the secondary case 52.

The attachment of the HC filter unit 100 to the secondary case 52 is performed as follows. As shown in FIG. 5, fixing bosses 70 are provided on the inner wall of the secondary case 52. An end of the fixing boss 70 is inserted into the attaching aperture 23 of the frame-like body 21 and flattened with staking welding or the like, thereby being fixed. To provide fixing bosses 70 at several places on the inner wall of the secondary case 52 and fix via them is sufficient, and the fixing bosses 70 are preferably placed so as to be as little of an obstacle as possible. In this case, a dedicated secondary case is not needed and a general secondary case can be used in common.

Alternatively, the attachment of the HC filter unit 100 to the secondary case 52 may be performed in such a way as shown in FIGS. 6A, 6B. As shown in FIG. 6A, a step is made in the wall of the secondary case 52 so as to form a receiving face 71, and the frame-like body 21 of the HC filter fixing frame 20 is fixed at the edges to the receiving face 71 with welding or adhesive. The step is preferably formed around the circumference of the secondary case 52 adjacent to the sealing faces. In this case, the receiving face 71 of the secondary case 52 and the outer edge faces of the frame-like body 21 can be joined together more tightly. Instead of the step made in the wall of the secondary case 52, fixing ribs (not shown) may be provided on the inner wall of the secondary case 52, which support and fix the attaching portion 21b.

Alternatively, as shown in FIG. 6B, fixing bosses 72 having a screw hole therein may be provided on the inner wall of the secondary case 52. The screw holes are aligned with the attaching apertures 23 of the frame-like body 21, and by inserting tapping screws 73, rivets, or the like, the frame-like body 21 may be fixed to the secondary case 52.

Alternatively, the HC filter unit 100 may be fixed to the secondary case 52 with a combination of the attaching structures of FIGS. 5, 6A, and 6B. For example, for the longitudinal sides of the four sides of the secondary case 52, the fixing bosses (see FIG, 5) are used, and for the transverse sides, the receiving face 71 is provided and used for fixing (see FIG. 6A). Alternatively, the fixing bosses 70 as shown in FIG. 5 may be formed protruding from the receiving face 71 of the step as shown in FIG. 6A and be staking welded. In this case, the HC filter unit 100 can be fixed to the secondary case 52 more reliably and firmly.

With the above configuration, at the engine start, taken-in air that has been taken through the inlet 51a of the primary case 51 into the air cleaner 200 passes through the air element 60 situated over the entire cross-section of the passage at a position adjacent to the sealing faces in the primary case 51 and flows into the secondary case 52. The air element 60 filters the taken-in air and removes dust and the like from it. The clean taken-in air having dust and the like removed flows out through the outlet 52a of the secondary case 52 and is supplied to the engine (not shown).

In contrast, while the engine is at rest, vaporized fuel is supplied from the engine side, and flows through the outlet 52a of the secondary case 52 into the air cleaner 200. The vaporized fuel that has flown into the air cleaner 200 then flows from the secondary case 52 into the primary case 51. At this time, the HC filter 10 of the HC filter unit 100 filters the vaporized fuel and removes hydrocarbon contained therein. Since the HC filter unit 100 and the HC filter 10 are situated over the entire cross-section of the passage at a position adjacent to the sealing faces in the secondary case 52, almost all of the hydrocarbon is removed. Hence, almost no hydrocarbon contained in the vaporized fuel gets into the primary case 51 and thus into the outside atmosphere through the inlet 51a of The primary case 51. By this means, the vaporized fuel can be prevented from polluting the air.

### EXAMPLE

A test was conducted to verify the effect of reducing the air-flow resistance in the air cleaner. For this example, a test model as shown in FIG. 7A was used wherein the HC filter 10 is situated over the entire cross-section of the passage at a position adjacent to the sealing faces in the secondary case 52. As controls, a comparison example 1 is the case where no HC filter is provided, and a comparison example 2 is the case where an HC filter of a seat type is provided. In any case, the rate of air flow was at 6.0 m³/minute. In the present example and the comparison examples 1, 2, the same secondary case 52 and HC filter fixing frame 20 were used. The test results are shown in FIG. 7B.

As shown in FIG. 7B, with the comparison example 2 where the HC filter of tie seat type is provided, the air-flow resistance was about 0.38 kpa higher than with the comparison example 1, but with the present example where the HC filter 10 is provided, the air-flow resistance was only about 0.1 kpa higher than with the comparison example 1. That is, it was verified that with the HC filter of the paper honeycomb type having its surface coated, the air-flow resistance is much less than with the HC filter of the seat type. Furthermore, it was perceived that the paper honeycomb structure itself has rectifying action and produces the effect of suppressing turbulence in the secondary case. With an HC filter of the conventional ceramic honeycomb type (not shown), the air-flow resistance was about twice higher than with the comparison example 2. As such, the HC filter of the paper honeycomb type having its surface coated according to the present invention can greatly reduce the air-flow resistance in the air cleaner.

What is claimed is:

1. An HC filter for use in an air cleaner that includes a housing having an inlet through which air is taken in from an outside atmosphere and an outlet through which the air taken in through the inlet is supplied to an engine; and an air element housed in the housing, filtering the air taken in through the inlet, the HC filter comprising:
an absorbent that absorbs hydrocarbon (HC) contained in vaporized fuel introduced through the outlet; and
a support that supports the absorbent,
wherein the HC filter defines an inside of the housing and is placed on the engine side of the air element, and the support is of a paper honeycomb structure and has a surface thereof coated.

2. An HC filter fixing frame for attaching an HC filter in a housing of an air cleaner, comprising:
a frame-like body having an opening formed therein that is open at both sides and having formed thereon opening side walls and an attaching portion at which the frame-like body is attachable to the housing, the opening side walls holding the HC filter at its outer edges, which filter is stored into the opening from one side of the frame-like body; and
a lattice provided on the other side of the frame-like body, dividing the opening into a plurality of sub-openings,
wherein the lattice is placed so as not to contact the stored HC filter, and bosses are provided on the side of the lattice facing the HC filter, which contact and hold the HC filter at a side thereof.

3. The HC fitter fixing frame according to claim 2, wherein the bosses are provided at intersections of the lattice.

4. An air cleaner comprising:
a housing having an inlet through which air is taken in from an outside atmosphere and an outlet through which the air taken in through the inlet is supplied to an engine;
an air element housed in the housing, filtering the air taken in through the inlet;
an HC filter defining an inside of the housing and being placed on the engine side of the air element, having an absorbent that absorbs hydrocarbon (HC) contained in vaporized fuel introduced through the outlet, and a support supporting the absorbent; and
an HC filter fixing frame for attaching the HC filter in the housing of the air cleaner,
wherein the support of the HC filter is of a paper honeycomb structure and has a surface thereof coated.

5. The air cleaner according to claim 4, wherein the HC filter fixing frame having:
a frame-like body having an opening formed therein that is open at both sides and having formed thereon opening side walls and an attaching portion at which the frame-like body is attachable to the housing, the opening side walls holding the HC filter at its outer edges, which filter is stored into the opening from one side of the frame-like body; and
a lattice provided on the other side of the frame-like body that divides the opening into a plurality of sub-openings,
wherein the lattice is placed so as not to contact the stored HC filter, and bosses are provided on the side of the lattice facing the HC filter, which contact and hold the HC filter at a side thereof.
